(19) United States
(12) Patent Application Publication
(10) Pub. No.: US 2026/0022224 A1
(43) Pub. Date: Jan. 22, 2026

(54) METHOD OF RECYCLING POLY(VINYL BUTYRAL) FROM MULTILAYER POLY(VINYL BUTYRAL) SHEETS

(71) Applicant: SOLUTIA INC., ST. LOUIS, MO (US)

(72) Inventors: SUNGKYUN SOHN, LONGMEADOW, MA (US); WENJIE CHEN, AMHERST, MA (US); PU ZHANG, SUFFIELD, CT (US); BERT JOZEF CAMPO, MELLE (BE)

(73) Assignee: SOLUTIA INC., ST. LOUIS, MO (US)

(21) Appl. No.: 18/875,462

(22) PCT Filed: Jun. 20, 2023
(86) PCT No.: PCT/US2023/068692

§ 371 Date: Dec. 16, 2024

Related U.S. Application Data
(60) Provisional application No. 63/356,693, filed on Jun. 29, 2022.

(51) Int. Cl. C08J 11/08; B29B 17/02; B29B 17/04; B29C 48/00; B29C 48/07; B29K 29/00; B29K 105/00; B32B 17/10; C08K 5/103

(52) U.S. Cl. CPC C08J 11/08; B29B 17/02; B29B 17/0412; B29C 48/022; B29C 48/07; B32B 17/10605; C08K 5/103; B29B 2017/0203; B29B 2017/0217; B29K 2029/00; B29K 2105/0038; C08J 2329/14

(57) ABSTRACT

A process is disclosed for recovering soft poly(vinyl butyral) from a plasticized poly(vinyl butyral) multilayer sheet comprising stiff poly(vinyl butyral) and soft poly(vinyl butyral). The multilayer sheet. which may be scrap or recycled material. is first converted to a granulate form and then treated with plasticizer. This plasticizer treatment serves to remove the soft poly(vinyl butyral) component from the granulate. but thereby provides a varnish comprising the soft poly(vinyl butyral) mixed with excess plasticizer. This varnish is however highly viscous and thus difficult to handle or mechanically process. The present disclosure provides a solution to this handling problem by the addition of soft poly(vinyl butyral) having a lower concentration of plasticizer to the varnish. until a product is obtained having a sufficiently low concentration of plasticizer to render the product capable of mechanical processing. for example pelletizing. The resulting product can then be utilized to form soft poly(vinyl butyral) sheets, thereby improving the recyclability of scrap multilayer poly(vinyl butyral) materials.

### FIELD OF THE INVENTION

This disclosure is related to the field of recycling polymer interlayers for multiple layer glass panels having at least one polymer interlayer sheet with multiple poly(vinyl butyral) components.

### BACKGROUND OF THE INVENTION

Laminated safety glass used in automobile windshields and architectural safety glass is typically composed of two sheets of glass laminated together with a plasticized polymer interlayer between them. Poly (vinylbutyral) (“PVB”) generally is the main component in the polymer interlayer.

The poly(vinyl butyral) resin is combined with plasticizer, typically before melt extrusion to sheet. Poly (vinyl butyral) resin and the plasticizer are typically manufactured through synthesis processes starting with the use of non-renewable feedstocks. Poly (vinyl butyral) is obtained by reaction of poly(vinyl alcohol) and butyraldehyde. The properties of poly(vinyl butyral) are determined by its molecular structure, which is characterized by parameters such as molecular weight and distribution thereof, residual hydroxyl content, and residual acetate content.

In recent years, a growing volume of multi-layer poly(vinyl butyral) interlayers for laminated glass has been sold to the market and has been applied in laminated safety glass. A multi-layer interlayer can provide enhanced sound insulation, by the presence of a softer layer in the center of the sheet (the “core layer”). Typically, the core layer composition, in terms of the amount of plasticizer relative to the amount of polymer, is different from the composition of the outer layers (the “skin layers”). The plasticizer content is typically higher in the core layer than it is in the skin layers. To enable such differences in composition between the layers, the PVB compound in the core layer has a composition which is different from the PVB compound in the skin layers in terms of hydroxyl content, possibly also in terms of residual poly(vinyl acetate) content.

Conventional multilayer interlayers such as a trilayer acoustic interlayer contain a soft core layer consisting of a single poly(vinyl butyral) (“PVB”) resin having a low residual hydroxyl content and a high amount of a conventional plasticizer, and two stiff skin layers having significantly higher residual hydroxyl content (see, for example U.S. Pat. Nos. 5,340,654, 5,190,826, and 7,510,771). Interlayers having the reverse configuration, that is, with one stiff layer sandwiched between two more soft layers have been found to improve the impact performance of the glass panel and can also be designed for sound insulation.

The following offers a simplified description of the manner in which multiple layer glass panels are generally produced in combination with these interlayers. First, at least one polymer interlayer sheet (single or multilayer) is placed between two substrates and any excess interlayer is trimmed from the edges, creating an assembly. It is not uncommon for multiple polymer interlayer sheets, or a polymer interlayer sheet with multiple layers (or a combination of both), to be placed within the two substrates, creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high-temperature and-pressure lamination process, or any other method known to one of ordinary skill in the art such as, but not limited to, autoclaving.

Trims or off-grade homogeneous poly(vinyl butyral) sheet products can be re-used in the sheet manufacturing process. After grinding, chips or flakes can be added again to the feed of the extrusion process. The PVB raw material can also be regained from laminated glass after it has served its purpose in an actual application. See U.S. Pat. Publication No. US2009/0209667. However, the presence of the core layer leads to a certain visual defect upon re-extrusion when applying such practices to a multi-layer sheet. Due to the differences in composition between PVB compounds in the skin and core layers, these materials do not mix well in the melt phase. This causes a specific type of haze to be visible in the laminated glass containing a PVB sheet in which pieces of a multi-layer sheet have been used in the raw material feed, which makes a product with inferior visual quality that is not appropriate for sales in the market.

The recycling of poly(vinyl butyral) multi-layer sheet from off grade finished sheet products that can't be re-used, and from laminated glass that has served its primary function and is being discarded, can be an economic and ecological step forward. It is likely less costly to recycle the finished sheet products, as compared to producing virgin poly(vinyl butyral) resin, while reducing the environmental footprint of poly(vinyl butyral) resin and sheet production. Maximizing scrap reuse is thus not only a competitive advantage, but also an environmentally sound practice.

U.S. Pat. Publication No. 2003/0191202 discloses a method for separating target polymers and their additives from a material containing polymers, as a result of which the recovery both of the target polymers and of the additives is made possible. Based on the principle of a selective precipitation, the target polymer is precipitated and subsequently separated from the additives present in solution and dissolved foreign polymers. The separation of the additives from the solution is effected in a further step.

U.S. Pat. Publication No. US 2009/0209667 discloses a method of recycling poly(vinyl butyral) resin, and incorporating that poly(vinyl butyral) resin into laminated glass and other articles. Poly (vinyl butyral) resin is recovered from discarded laminated glass through a well-defined process, that includes the steps of granulation of the laminated glass, solvent extraction of plasticizer and impurities, dissolution of poly(vinyl butyral), pre-filtration of insoluble contaminants, color removal via adsorption or bleaching, post-filtration of carbon particles, precipitation of poly(vinyl butyral), and washing, stabilization, and drying of poly(vinyl butyral) resin. In one embodiment, a method is disclosed to separate two poly(vinylbutyral) resins from a single batch of granules. For this embodiment, a solvent is chosen for the dissolution step that selectively dissolves at a suitable temperature a first poly(vinylbutyral) resin and not a second poly(vinyl butyral) resin. There remains a need for methods of recycling PVB scrap material.

### SUMMARY OF THE INVENTION

In summary, the invention provides a process for recovering soft poly(vinyl butyral) from a plasticized poly(vinyl butyral) multilayer sheet comprising stiff poly(vinyl butyral) and soft poly(vinyl butyral). The multilayer sheet, which may be scrap or recycled material, is first converted to a granulate form and then treated with plasticizer. This plasticizer treatment serves to remove the soft poly(vinyl butyral) component from the granulate, and thereby provides a varnish comprising the soft poly(vinyl butyral) mixed with excess plasticizer. This varnish is however highly viscous and thus difficult to handle or mechanically process. The present invention provides a solution to this handling problem by the addition of soft poly(vinyl butyral) having a lower concentration of plasticizer to the varnish, until a product is obtained having a sufficiently low concentration of plasticizer to render the product capable of mechanical processing, for example pelletizing. The resulting product can then be utilized to form soft poly(vinyl butyral) sheets, thereby improving the recyclability of scrap multilayer poly(vinyl butyral) materials.

### DETAILED DESCRIPTION

In a first aspect, the invention provides a process for recovering soft poly(vinyl butyral) from a plasticized poly(vinyl butyral) multilayer sheet comprising stiff poly(vinyl butyral) and soft poly(vinyl butyral), the process comprising:
a. grinding the plasticized poly(vinyl butyral) multilayer sheet to obtain a poly(vinyl butyral) granulate;
b. adding additional plasticizer to the poly(vinyl butyral) granulate to remove at least a portion of the soft poly(vinyl butyral) from the poly(vinyl butyral) granulate to obtain (i) a granulate enriched in the stiff poly(vinyl butyral) and (ii) a varnish of the soft poly(vinyl butyral) and the additional plasticizer;
c. physically separating the granulate enriched in the stiff poly(vinyl butyral) from the varnish of the soft poly(vinyl butyral) and the additional plasticizer, wherein the varnish has a first concentration of plasticizer; and
d. adding under-plasticized poly(vinyl butyral) to the varnish, to provide a soft poly(vinyl butyral) composition having a lower concentration of plasticizer than the first concentration.

In co-pending application PCT/2022/011518, incorporated herein by reference in its entirety, Applicant describes a process for recovering stiff poly(vinyl butyral) from a plasticized poly(vinyl butyral) multilayer sheet containing both the stiff and soft poly(vinyl butyral) materials. One by-product of this process is a highly-viscous varnish comprised of excess plasticizer having soft poly(vinyl butyral) dissolved therein, thereby providing a viscous liquid varnish. For example, a varnish that contains 10 weight percent soft poly(vinyl butyral) exhibits a viscosity of over 20 Pa-sec at 25° C., and one that contains 15 weight percent soft poly(vinyl butyral) exhibits a viscosity of over 150 Pa-sec at 25° C. The challenges around handling such a high viscosity varnish during transport, storage, use, and clean-up in a commercial extrusion process make most of the efforts to re-use the varnish in a poly(vinyl butyral) sheet extrusion process challenging and potentially undesirable for implementation.

The present invention provides a solution to this problem of recovery of the soft poly(vinyl butyral) materials by providing a form that can be more easily processed and recycled. The present invention provides a practical method of re-using the varnish by converting the varnish into a poly(vinyl butyral) composition, and ultimately pellets with an intermediate level of plasticizer through compounding the varnish with soft poly(vinyl butyral) resin which is significantly reduced in plasticizer content, hereinafter “under-plasticized” soft poly(vinyl butyral). In general terms, such an under-plasticized soft poly(vinyl butyral) may contain about 0 to about 45 phr (phr=parts of plasticizer per hundred of resin) of plasticizer, or in other embodiments about 0 to about 5, or about 0 to about 2, or about 0 to about 1 phr of plasticizer. In this manner, the viscous varnish is converted to a more workable product, which is ultimately capable of extrusion into re-usable pellets of soft poly(vinyl butyral). In one embodiment, the under-plasticized soft poly(vinyl butyral) resin to be added to the varnish is in the form of a powder containing no plasticizer. In this regard, the under-plasticized soft poly(vinyl butyral) can contain some plasticizer, but since the overall target level of plasticizer in the soft poly(vinyl butyryl) product to be isolated comprises desirably about 20 to 80 phr of plasticizer, there is a practical limit on the amount of plasticizer present in the under-plasticized soft poly(vinyl butyral) in the practice of the invention, insofar as the starting material varnish in this case (i.e., in step c.) generally ranges from about 300 to 1900 phr plasticizer.

In other embodiments, the soft poly(vinyl butyral) composition to be isolated in step d. above comprises about 30 to about 45, or about 35 to about 40 phr of plasticizer.

In the practice of the present invention, the varnish recited in c. above generally contains about 5 to 25 weight percent of soft core poly(vinyl butyral) resin in the plasticizer, or in other embodiments, about 12 to 18 weight percent, based on the total weight of the plasticizer and soft poly(vinyl butyral).

Any conventional compounder, including but not limited to, an intermeshing, co-rotating twin-screw extruder could be used to carry out the compounding process at temperatures between about 80-200° C. to afford the soft poly(vinyl butyral) pellets, which in certain embodiments, comprise about 20 to 80 phr of plasticizer.

Co-pending application PCT/2022/011518, referred to above, relates to the first three steps set forth above as a. through c., as a means to isolate the stiff poly(vinyl butyral) portion from the multilayer scrap material. In other words, steps a. through c. recite a process where a plasticized poly(vinyl butyral) multilayer sheet containing both soft and stiff poly(vinyl butyral) components is converted to a granulate, which is then treated with plasticizer to wash or remove at least a portion of the soft poly(vinyl butyral) from the granulate as a way of obtaining a granulate which is enriched in the stiff poly(vinyl butyral).

If the target plasticizer content in the pellet is lower than 20 phr, it becomes extremely difficult to uniformly compound the varnish with the soft poly(vinyl butyral) resin powder, without causing thermal degradation. If the target plasticizer content in the pellet is above 80 phr, the glass transition temperature of the pellet becomes too low, necessitating extremely cold temperature for storage and transport of the pellets.

Thus, in a further embodiment, the invention provides the above process, further comprising the step of converting the soft poly(vinyl butyral) composition in step d. having a concentration of plasticizer in the range of about 20 to about 80 phr, into a pellet form. In one embodiment, the pellets are dusted with a soft poly(vinyl butyral) resin in powder form, wherein the powder has less than or equal to about 1 phr of plasticizer.

The soft poly(polyvinyl butyral) pellets of the present invention, which are the ultimate product of the process of the invention, can be any suitable shape and size, depending on the given application. In various embodiments of the present invention, pellets can be at least 1 milligram, at least 10 milligrams, at least 100 milligrams, at least 1 gram, or at least 5 grams. Pellets having lower or higher masses are also within the scope of the present invention. In various embodiments, pellets of the present invention are between 0.1 and 100 milligrams, 3 and 20 milligrams, or 5 and 20 milligrams. In various embodiments of the present invention, pellets can be less than 3 centimeters, less than 2 centimeters, less than 1 centimeter, or less than 0.5 centimeters across the greatest dimension. In various embodiments pellets can be from 1-5 millimeters across the greatest dimension. Pellet shape can be any conventionally used pellet shape, for example, spherical, ovate, rectilinear; cylindrical, cubic, and the like, as well as irregular shapes. In other embodiments, pellets of the present invention are micro-pellets having a greatest dimension as Small as 10 micrometers and a mass as Small as 4 nanograms. Mixtures of pellets of different dimensions, as given above, are also within the scope of the present invention. The present invention includes batches of pellets, for example batches having more than 1, more than 100, more than 1,000, or more than 10,000 pellets. The present invention also includes containers containing pellets of the present invention, including containers containing, more than 1, more than 100, more than 1,000, or more than 10,000 pellets.

The soft poly(vinyl butyral) pellets of this invention can be added either to a continuous mixer where it is mixed with additional plasticizer to match the target plasticizer level, and other additives as necessary, or directly to an extruder before where additional plasticizer and other additives are injected.

As used herein, the term “varnish” is used to describe the resulting soft poly(vinyl butyral) and additional plasticizer when a granulate has been enriched in the stiff poly(vinyl butyral) granulate by use of a plasticizer. Plasticizers such as those typically used to plasticize poly(vinyl butyral) may be used to selectively wash away or extract the soft poly(vinyl butyral) from the granulated poly(vinyl butyral) mixtures to obtain a granulate enriched in stiff poly(vinyl butyral) and a varnish which may be used to produce a poly(vinyl butyral) interlayer, such as an acoustic interlayer, as it contains essentially only soft poly(vinyl butyral).

In one embodiment, the soft poly(vinyl butyral) may have a residual hydroxyl content from about 8% to about 12%. In another embodiment, the stiff poly(vinyl butyral) may have a residual hydroxyl content of from about 15% to about 25%.

In a further embodiment, the plasticized poly(vinyl butyral) multilayer sheet may comprise triethylene glycol bis(2-ethylhexanoate) present as a plasticizer. In other embodiments, the plasticized poly(vinyl butyral) multilayer sheet may further comprise dihexyladipate or bis(2-ethylhexyl) adipate or another convenient substance such as Benzoflex™ 9-88 benzoate ester as a plasticizer.

In other embodiments, the additional plasticizer is selected from one or more of esters of a polybasic acid or a polyhydric alcohol. In further embodiments, the additional plasticizer may be selected from one or more of: triethylene glycol bis(2-ethylhexanoate), tetraethylene glycol bis(2-ethylhexanoate), triethylene glycol bis(2-ethylbutyrate), triethylene glycol diheptanoate, tetraethylene glycol diheptanoate, dihexyl adipate, bis(2-ethylhexyl) adipate, bis(2-ethoxyethyl) adipate, dioctyl adipate, hexyl cyclohexyladipate, diisononyl adipate, heptylnonyl adipate, dibutyl sebacate, polymeric adipates, a soybean oil, or an epoxidized soybean oil.

In a further embodiment, the difference between the residual hydroxyl content of the soft poly(vinyl butyral) and the residual hydroxyl content of the stiff poly(vinyl butyral) is at least 4.0 weight percent.

In a further embodiment, the stiff poly(vinyl butyral) contained in the plasticized poly(vinyl butyral) multilayer sheet comprises from about 30 phr to about 45 phr plasticizer. In one embodiment, the soft poly(vinyl butyral) may be isolated from the mixture of soft poly(vinyl butyral) and additional plasticizer resulting from step b. via one or more of sedimentation, filtration, centrifugation, evaporation, or precipitation to isolate the soft poly(vinyl butyral).

The term “stiff poly(vinyl butyral)” refers to a poly(vinyl butyral) resin, or a blend of poly(vinyl butyral) resins, that is significantly stiffer than “soft poly(vinyl butyral),” typically forming a skin or stiff layer of a multilayer poly(vinyl butyral) multilayer sheet, as further described herein.

The term “soft poly(vinyl butyral)” refers to a poly(vinyl butyral) resin, or a blend of poly(vinyl butyral) resins, that is significantly softer than “stiff poly(vinyl butyral),” typically forming a core or soft layer of a multilayer poly(vinyl butyral) multilayer sheet, as further described herein. The soft or core poly(vinyl butyral) layer is typically sandwiched between two stiff or skin poly(vinyl butyral) layers to form a multilayer poly(vinyl butyral) multilayer sheet.

The term “plasticizer” as used herein refers generally to a molecule or blend of molecules, as further described herein, that plasticizes a polymer at lower plasticizer content, specifically poly(vinyl butyral), thereby softening it. Further, the plasticizers, useful according to the invention as additional plasticizers, help remove the soft poly(vinyl butyral) s from the granulated poly(vinyl butyral) mixtures by selectively washing or partially dissolving the soft poly(vinyl butyral) when present as additional plasticizer in higher amounts, due to the higher affinity or compatibility of the core layer for the plasticizer, as evidenced in part by its lower residual hydroxyl content.

In some embodiments, the additional plasticizer has a hydrocarbon segment of fewer than 20, fewer than 15, fewer than 12, or fewer than 10 carbon atoms. Suitable additional plasticizers for use according to the invention include esters of a polybasic acid or a polyhydric alcohol, among others. Suitable plasticizers include, for example, triethylene glycol bis(2-ethylhexanoate) (“3-GEH”), tetraethylene glycol bis(2-ethylhexanoate), triethylene glycol bis(2-ethylbutyrate), triethylene glycol diheptanoate, tetraethylene glycol diheptanoate, dihexyl adipate, bis(2-ethylhexyl) adipate, dioctyl adipate, hexyl cyclohexyladipate, diisononyl adipate, heptylnonyl adipate, dibutyl sebacate, polymeric adipates, soybean oils, and epoxidized soybean oils, and mixtures thereof. In one embodiment, the plasticizer is 3-GEH.

Additionally, plasticizers that are compatible in high temperatures may be utilized to further increase the flow of the interlayer.

The term “poly(vinyl butyral) multilayer sheet,” as used herein, refers to a sheet comprised of different layers of poly(vinyl butyral) resins, typically a soft or core layer, having a stiff, or skin, layer on each side of the core layer. The poly(vinyl butyral) multilayer sheets of the invention thus comprise at least one soft poly(vinyl butyral) and at least one stiff poly(vinyl butyral).

When we say that the poly(vinyl butyral) multilayer sheet is ground to obtain a granulated poly(vinyl butyral) mixture, we mean that it is reduced in size by any suitable means, for example a grinder, to obtain granulates, chips, flakes, or the like, all of which may be considered granulates according to the invention. In this granulation step, the granulation can be performed using any suitable device, which can be, for example, a commercial granulator such as a Granutec granulator (East Douglas, Mass., USA). The scrap is granulated to reduce the particle size. Granulation of scrap can result in individual granulates that have a long dimension of less than 2.6 centimeters, or 0.1 to 1.0 centimeters, or 0.4 to 0.8 centimeters. While granulates above 2.6 centimeters in size can be used, it is generally desirable to granulate the sheet to a smaller size, which results in a greater total granulate surface area. At any point during granulation, the granulated flakes can be sifted to remove contaminants freed from the poly(vinyl butyral).

When we say that additional plasticizer is added to the poly(vinyl butyral) granulate, we mean that the plasticizer added in this step is in addition to the plasticizer contained in the plasticized poly(vinyl butyral) multilayer sheet. Indeed, both the soft poly(vinyl butyral) and the stiff poly(vinyl butyral) will already contain plasticizer. The additional plasticizer may be the same plasticizer present in the soft poly(vinyl butyral) and/or the stiff poly(vinyl butyral), or it may be different than that present in the soft poly(vinyl butyral) and/or the stiff poly(vinyl butyral). The amount of additional plasticizer added is sufficient to assist in removing or washing at least a portion of the soft poly(vinyl butyral) from the poly(vinyl butyral) granulates to obtain a soft poly(vinyl butyral) and plasticizer varnish.

When we say that at least a portion of the soft poly(vinyl butyral) is removed from the poly(vinyl butyral) granulates, we mean that a portion of the soft poly(vinyl butyral) is washed or dissolved from the granulates. The granulates may thereafter be separated from the soft poly(vinyl butyral) and additional plasticizer according to one or more of the following techniques, as further described herein: decanting, filtering, or centrifuging.

When we say that the granulates are enriched in the stiff poly(vinyl butyral), we mean that the relative amount of the stiff poly(vinyl butyral) in the granulates is higher than it was before a portion of the soft poly(vinyl butyral) was washed from the granulates.

In one embodiment, the soft or core poly(vinyl butyral) or blend of soft poly(vinyl butyral) s, may have a residual hydroxyl content, as further described herein, from about 5% to about 15%. Alternatively, the residual hydroxyl content of the core poly(vinyl butyral) may be from about 7% to about 13, or from 8% to 12%, or as further described herein.

In one embodiment, the soft or core poly(vinyl butyral) or blend of soft poly(vinyl butyral)s, may have a residual acetate content, as further described herein, from about 0% to about 18%. Alternatively, the residual acetate content may be less than 10%, or less than 5%, or less than 2%, or less than 1%, or as further described herein.

The amount of plasticizer in the soft or core poly(vinyl butyral) or a blend of soft poly(vinyl butyral), may be from about 50 phr to about 150 phr, or from 55 phr to 120 phr, or from 60 to 100 phr.

In another embodiment, the stiff poly(vinyl butyral) or blend of stiff poly(vinyl butyral) s, may have a residual hydroxyl content, as further described herein, from about 12% to about 28%. Alternatively, the residual hydroxyl content of the stiff poly(vinyl butyral) may be from about 15% to about 25%, or from 18% to 20%, or as further described herein.

In another embodiment, the stiff poly(vinyl butyral) or blend of stiff poly(vinyl butyral)s, may have a residual acetate content, as further described herein, from about 0% to about 18%. Alternatively, the residual acetate content of the stiff poly(vinyl butyral) may be less than 10%, or less than 5%, or less than 2%, or less than 1%, or as further described herein.

In other embodiments, the residual hydroxyl content of the core layer can be the same as, greater than, or less than the residual hydroxyl content of the resin in the skin layer. In various embodiments, the core resin, or skin resin or both of these resins, may comprise less than 30 wt. % residual ester groups, less than 25 wt. % residual ester groups, less than 20 wt. %, less than 15 wt. %, less than 13 wt. %, less than 10 wt. %, less than 7 wt. %, less than 5 wt. %, or less than 1 wt. % residual ester groups calculated as polyvinyl ester, e.g., acetate, with the balance being an acetal, such as butyraldehyde acetal, but optionally being other acetal groups, such as an isobutyraldehyde acetal group, a 2-ethyl hexanal acetal group, or a mix of any two of butyraldehyde acetal, isobutyraldehyde acetal, and 2-ethyl hexanal acetal groups, or as discussed elsewhere herein.

In one embodiment, the multilayered interlayers may comprise: a first skin polymer layer comprising plasticized poly(vinyl butyral) having a molecular weight of less than about 140,000 Daltons; a second core polymer layer comprising plasticized poly(vinyl butyral) having a molecular weight of greater than about 140,000 Daltons; and a third skin polymer layer comprising plasticized poly(vinyl butyral) having a molecular weight of less than about 140,000 Daltons. The second polymer layer is disposed between the first polymer layer and the third polymer layer, resulting in two skin layers and a central core layer.

In various embodiments of interlayers of the present disclosure, the interlayer may comprise about 30 to about 60 phr (parts per hundred parts resin) total plasticizer. While the total plasticizer content is indicated above, the plasticizer content in the skin layer(s) or core layer(s) can be different from the total plasticizer content. In addition, the skin layer(s) and core layer(s) can have different plasticizer contents, as each respective layer's plasticizer content at the equilibrium state is determined at least in part by its respective residual hydroxyl content. For example, at equilibrium the interlayer could comprise two skin layers, each with 38 phr plasticizer, and a core layer with 75 phr plasticizer, for a total plasticizer amount for the interlayer of about 54.3 phr when the combined skin layer thickness equals that of the core layer. For thicker or thinner skin layers, the total plasticizer amount for the interlayer may change accordingly.

In other embodiments, the amount of plasticizer in the stiff or skin poly(vinyl butyral) or blend of soft poly(vinyl butyral) s may be from about 20 phr to about 60 phr, or from 25 phr to 50 phr, or from 30 to 45 phr.

In a further embodiment, the difference between the residual hydroxyl content of the soft poly(vinyl butyral) and the residual hydroxyl content of the stiff poly(vinyl butyral) is at least 6%, or at least 5%, or at least 4%, or from 4% to 8%, or from 5% to 10%, or as further described herein.

Thus, in various embodiments, the residual hydroxyl contents of the poly(vinyl butyral) resins for skin layer(s) and core layer(s) may be different. The resin for the core layer(s), for example, can comprise about 9 to about 18 weight percent (wt. %) residual hydroxyl groups calculated as PVOH, about 9 to about 16 wt. % residual hydroxyl groups calculated as PVOH, or about 9 to about 14 wt. % residual hydroxyl groups calculated as PVOH. The resin for the skin layer(s), for example, can comprise about 13 to about 35 weight percent (wt. %) residual hydroxyl groups calculated as PVOH, about 13 to about 30 wt. % residual hydroxyl groups calculated as PVOH, or about 15 to about 22 wt. % residual hydroxyl groups calculated as PVOH; and, for certain embodiments, about 17.25 to about 22.25 wt. residual hydroxyl groups calculated as PVOH, or as described elsewhere herein. The resin for the core layer(s) or for the skin layer(s) or for both the skin layer(s) and core layer(s) can also comprise less than 20 wt. % residual ester groups, less than 15 wt. %, less than 13 wt. %, less than 11 wt. %, less than 9 wt. %, less than 7 wt. %, less than 5 wt. %, or less than 1 wt. % residual ester groups calculated as polyvinyl ester, e.g., acetate, with the balance being an acetal, preferably butyraldehyde acetal, but optionally including other acetal groups in a minor amount, for example, a 2-ethyl hexanal group (see, for example, U.S. Pat. No. 5,137,954, the entire disclosure of which is incorporated herein by reference).

In one embodiment, the soft poly(vinyl butyral), the stiff poly(vinyl butyral), and/or the plasticized poly(vinyl butyral) multilayer sheet, or any other poly(vinyl butyral) described herein, may include a plasticizer selected from one or more of dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bisphenol A bis(2-ethylhexaonate), di-(butoxyethyl) terephthalate, di (butoxyethyoxyethyl) terephthalate, bis(2-ethoxyethyl) adipate, or as further described herein.

In various embodiments, the additional plasticizer added may comprise one or more of dipropylene glycol dibenzoate, tripropylene glycol dibenzoate, polypropylene glycol dibenzoate, isodecyl benzoate, 2-ethylhexyl benzoate, diethylene glycol benzoate, butoxyethyl benzoate, butoxyethyoxyethyl benzoate, butoxyethoxyethoxyethyl benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bisphenol A bis(2-ethylhexaonate), di-(butoxyethyl)terephthalate, di(butoxyethyoxyethyl)terephthalate, or as further described herein, and may be the same or different than the plasticizer in the poly(vinyl butyral)s as just described, as further described herein. Further plasticizers suitable as the additional plasticizer or the plasticizer in the soft poly(vinyl butyral) are described elsewhere herein.

As noted, the poly(vinyl butyral) multilayer sheets of the invention typically comprise a stiff poly(vinyl butyral) layer and a soft poly(vinyl butyral) layer. As noted, the core layer typically comprises soft poly(vinyl butyral) sandwiched between stiff poly(vinyl butyral) skin layers to form the poly(vinyl butyral) multilayer sheets of the invention.

In one embodiment, the amount of additional plasticizer added to the poly(vinyl butyral) granulate is sufficient to wash, extract, or selectively dissolve a portion of the soft poly(vinyl butyral).

In another embodiment, the amount of additional plasticizer added to the poly(vinyl butyral) granulate is sufficient to suspend the stiff poly(vinyl butyral) granulates of the mixture, thus forming a stiff poly(vinyl butyral) suspension.

In yet another embodiment, the additional plasticizer is added to the poly(vinyl butyral) granulate in a continuous process, for example to form a countercurrent process, to remove at least a portion of the soft poly(vinyl butyral) from the poly(vinyl butyral) granulate such that the granulate is enriched in the stiff poly(vinyl butyral). This granulate may then be separated from the resulting varnish mixture of the soft poly(vinyl butyral) and the additional plasticizer, or the varnish may be used without separating the additional plasticizer from the soft poly(vinyl butyral), or only partially separating the additional plasticizer from the soft poly(vinyl butyral), or only separating water from the mixture.

In another embodiment, the invention relates to a poly(vinyl butyral) sheet comprising the isolated soft poly(vinyl butyral), as well as to a laminated glass comprising this poly(vinyl butyral) sheet.

In further embodiments, the invention relates to poly(vinyl butyral) sheets that comprise the soft poly(vinyl butyral), and laminated glass comprising these poly(vinyl butyral) sheets.

When we say that the stiff poly(vinyl butyral) is separated from the poly(vinyl butyral) mixture by decanting or sedimentation, we mean that the liquid is separated from the stiff poly(vinyl butyral) solids, for example, by letting the solids settle to the bottom of the vessel, and removing the bulk of the additional plasticizer from the granulates.

When we say that the stiff poly(vinyl butyral) is separated by filtering, we mean that the stiff poly(vinyl butyral) solids of the granulates are filtered from the plasticizer.

When we say that the stiff poly(vinyl butyral) is separated from the mixture by centrifuging, we mean that the solids are separated from the liquid using a centrifuge.

The invention may be further understood according to the following further description.

Thus, in one embodiment, the multilayered poly(vinyl butyral) sheets of the invention may comprise interlayers comprising one or more stiff skin layers and a soft core layer(s). In an embodiment, these multilayered interlayer sheets may comprise: a first polymer layer (skin layer) comprising a stiff plasticized poly(vinyl butyral) resin; a second polymer layer (core layer) comprising a soft plasticized poly(vinyl butyral) resin, or a blend thereof having the same or different residual hydroxyl content; and optionally a third polymer layer (skin layer) comprising stiff plasticized poly(vinyl butyral) resin. The second or core polymer layer is disposed adjacent the first polymer layer. If there are three or more layers, the second polymer layer may be disposed between the first polymer layer and the third polymer layer, resulting in two skin layers and a central core layer.

In embodiments, the second or core poly(vinyl butyral) resin may be present in an amount of from about 2 weight percent to about 45 weight percent, or from about 5 weight percent to about 40 weight percent.

In embodiments, the residual hydroxyl content of the third or stiff poly(vinyl butyral resin) is typically the same as the residual hydroxyl content of the first stiff poly(vinyl butyral resin) and typically differs from that in the second or core poly(vinyl butyral resin). In embodiments, the difference between the core residual hydroxyl content and the skin residual hydroxyl content is at least 4.0 weight percent, or at least 6.0 weight percent.

In embodiments, the second poly(vinyl butyral) resin is present in an amount of from about 2 weight percent to about 45 weight percent, or from about 5 weight percent to about 40 weight percent.

In embodiments, the polymer interlayer has at least two different glass transition temperatures (T_{g}) and the difference between at least two different glass transition temperatures (T_{g}) is at least 5° C.

In embodiments, the residual hydroxyl content of the third, or skin, poly(vinyl butyral resin) is the same as the residual hydroxyl content of the first, or core, poly(vinyl butyral) resin.

In one embodiment of the invention, a single plasticizer such as triethylene glycol bis(2-ethylhexanoate) may be used, or mixtures of this with dihexyladipate.

The invention thus relates to a method of using plasticizer as an extractant to preferentially remove, wash, or partially dissolve the soft poly(vinyl butyral) resin from the poly(vinyl butyral) granulate by taking advantage of solubility differences of the PVB components in the plasticizer. This is distinguished from the use of traditional solvents. The present invention therefore affords a way of reclaiming raw material for reintroduction into the manufacturing processes.

Because of the difference in the cloud points of the poly(vinyl butyral) resin of different compositions, specifically, as measured by residual % polyvinyl alcohol (PVOH), in the plasticizer, the technique allows the use of temperature as a key parameter for effective separation of different poly(vinyl butyral) components. In this respect, the additional plasticizer may be added to the poly(vinyl butyral) granulate at a temperature of at least 25°, or at least 30° C., or from about 25° C. to about 90° C., or 30° C. to about 60° C., or as disclosed elsewhere herein.

The poly(vinyl butyral) compounds are components of a multilayer poly(vinyl butyral) sheet, where each layer is composed of a poly(vinyl butyral) and a plasticizer with different compositions in terms of the poly(vinyl butyral) composition, i.e., a different residual hydroxyl or residual acetate content, and plasticizer content. Mostly, the amount of plasticizer relative to the amount of poly(vinyl butyral) is different. Significant extraction of a poly(vinyl butyral) compound from a multi-layer sheet granulate is typically obtained after grinding the off grade sheet to smaller flakes, generally to a size ranging from 3 to 30 mm.

The degree of separation is depending on the applied plasticizer, e.g., the extraction of core layer PVB from a poly(vinyl butyral) multi-layer sheet using triethylene glycol bis(2-ethylhexanoate) proceeds to an extent that 25 to 50% of core layer PVB is removed in a single fractionation step. Repeating the extraction will increase the extent of separation between the different poly(vinyl butyral) compounds. Typically, extraction is obtained when multi-layer sheet or parts thereof are exposed to a specific solvent in a temperature range between 25 and 100° C., with extraction times between 5 mins and several days for one extraction cycle.

Conventional multilayer interlayers such as a tri-layer acoustic interlayer typically contain a soft core layer consisting of a single poly(vinyl butyral) (“PVB”) resin having a low residual hydroxyl content and a high amount of a conventional plasticizer, and two stiff skin layers having significantly higher residual hydroxyl content (see, for example U.S. Pat. No. 5,340,654, 5,190,826, and 7,510,771). Thus, the isolated soft poly(vinyl butyral) may be recycled to form the core layer of a trilayer acoustic interlayer, or the soft poly(vinyl butyral) and plasticizer varnish may be used directly to form a soft poly(vinyl butyral) layer without first separating the two. The residual hydroxyl content in the PVB core resin and the amount of the plasticizer are optimized such that the interlayer provides optimal sound insulation property under ambient conditions for multiple layer glass panels such as windshields and windows installed on vehicles and buildings.

The PVB resin is produced by known acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Vinyl Acetal Polymers, in Encyclopedia of Polymer Science & Technology, 3rd edition, Volume 8, pages 381-399, by B.E. Wade (2003), the entire disclosures of which are incorporated herein by reference. The resin is commercially available in various forms, for example, as Butvar® Resin from Solutia Inc., a wholly owned subsidiary of Eastman Chemical Company.

As used herein, residual hydroxyl content (calculated as percent vinyl alcohol or percent PVOH by weight) in poly(vinyl butyral) refers to the amount of hydroxyl groups remaining on the polymer chains after processing is complete. For example, poly(vinyl butyral) can be manufactured by hydrolyzing poly(vinyl acetate) to poly(vinyl alcohol (PVOH), and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished poly(vinyl butyral) resin, there typically will be residual acetate groups (as vinyl acetate groups) and residual hydroxyl groups (as vinyl hydroxyl groups) as side groups on the polymer chain. As used herein, residual hydroxyl content and residual acetate content is measured on a weight percent (weight percent) basis per ASTM D1396.

The poly(vinyl butyral) resins of the present disclosure typically have a molecular weight of greater than 50,000 Daltons, or less than 500,000 Daltons, or about 50,000 to about 500,000 Daltons, or about 70,000 to about 500,000 Daltons, or about 100,000 to about 425,000 Daltons, as measured by size exclusion chromatography using low angle laser light scattering. As used herein, the term “molecular weight” means the weight average molecular weight.

Various adhesion control agents (“ACAs”) can be used in the interlayers of the present disclosure to control the adhesion of the interlayer sheet to glass. In various embodiments of interlayers of the present disclosure, the interlayer can comprise about 0.003 to about 0.15 parts ACAs per 100 parts resin; about 0.01 to about 0.10 parts ACAs per 100 parts resin; and about 0.01 to about 0.04 parts ACAs per 100 parts resin. Such ACAs, include, but are not limited to, the ACAs disclosed in U.S. Pat. No. 5,728,472 (the entire disclosure of which is incorporated herein by reference), residual sodium acetate, potassium acetate, magnesium bis(2-ethyl butyrate), and/or magnesium bis(2-ethylhexanoate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers, among other additives known to those of ordinary skill in the art.

In various embodiments of interlayers of the present disclosure, the interlayer comprises greater than 5 phr, about 5 to about 120 phr, about 10 to about 90 phr, about 20 to about 70 phr, about 30 to about 60 phr, or less than 120 phr, or less than 90 phr, or less than 60 phr, or less than 40 phr, or less than 30 phr total plasticizer. While the total plasticizer content is indicated above, the plasticizer content in the skin layer(s) or core layer(s) can be different from the total plasticizer content. In addition, the skin layer(s) and core layer(s) can have different plasticizer types and plasticizer contents, in the ranges previously discussed, as each respective layer's plasticizer content at the equilibrium state is determined by the layer's respective residual hydroxyl contents, as disclosed in U.S. Pat. No. 7,510,771 (the entire disclosure of which is incorporated herein by reference). For example, at equilibrium the interlayer could comprise two skin layers, each with 30 phr plasticizer, and a core layer with 65 phr plasticizer, for a total plasticizer amount for the interlayer of about 45.4 phr when the combined skin layer thickness equals that of the core layer. For thicker or thinner skin layers, the total plasticizer amount for the interlayer would change accordingly. In various embodiments of the present invention, the plasticizer content of the core layer and skin layer differs by at least 8 phr, or at least 9 phr, or at least 10 phr, or at least 12 phr, or at least 13 phr, or at least 14 phr, or at least 15 phr, or at least 16 phr, or at least 17 phr, or at least 18 phr, or at least 19 phr, or at least 20 phr, or at least 25 phr or more. As used herein, the amount of plasticizer, or any other component in the interlayer, can be measured as parts per hundred parts resin (phr), on a weight per weight basis. For example, if 30 grams of plasticizer is added to 100 grams of polymer resin, then the plasticizer content of the resulting plasticized polymer would be 30 phr. As used herein, when the plasticizer content of the interlayer is given, the plasticizer content is determined with reference to the phr of the plasticizer in the mix or melt that was used to produce the interlayer.

The final interlayer, whether formed from extrusion or coextrusion, generally has a random rough surface topography as it is formed through melt fractures of polymer melt as it exits the extrusion die and may additionally be embossed over the random rough surface on one or both sides (e.g., the skin layers) by any method of embossment known to one of ordinary skill in the art.

While all methods for the production of polymer interlayer sheets known to one of ordinary skill in the art are contemplated as possible methods for producing the polymer interlayer sheets described herein, this application will focus on polymer interlayer sheets produced through the extrusion and coextrusion processes. The final multiple layer glass panel laminate of the present invention are formed using lamination processes known in the art.

Generally, the thickness, or gauge, of the polymer interlayer sheet will be in a range from about 15 mils to 100 mils (about 0.38 mm to about 2.54 mm), about 15 mils to 60 mils (about 0.38 mm to about 1.52 mm), about 20 mils to about 50 mils (about 0.51 to 1.27 mm), and about 15 mils to about 35 mils (about 0.38 to about 0.89 mm). In various embodiments, each of the layers, such as the skin and core layers, of the multilayer interlayer may have a thickness of about 1 mil to 99 mils (about 0.025 to 2.51 mm), about 1 mil to 59 mils (about 0.025 to 1.50 mm), 1 mil to about 29 mils (about 0.025 to 0.74 mm), or about 2 mils to about 28 mils (about 0.05 to 0.71 mm).

Although the embodiments described below refer to the polymer resin as being poly(vinyl butyral) PVB, it would be understood by one of ordinary skill in the art that the polymer may be any polymer suitable for use in a multiple layer panel. Typical polymers include, but are not limited to, polyvinyl acetals (PVA) (such as PVB or isomeric poly(vinyl isobutyral) (PVisoB), polyurethane (PU), poly(ethylene-co-vinyl acetate) (EVA), polyvinylchloride (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and its ionomers, derived from any of the foregoing possible thermoplastic resins, combinations of the foregoing, and the like. PVB and its isomeric polymer PVisoB, polyvinyl chloride, and polyurethane are particularly useful polymers generally for interlayers; PVB (and its isomeric polymer) is particularly preferred. For example, the multilayered interlayer can consist of PVB//PVisoB//PVB. Other examples include PVB//PVC//PVB or PVB//PU//PVB. Further examples include PVC//PVB//PVC or PU//PVB//PU.

As used herein, a multiple layer panel can comprise a single substrate, such as glass, acrylic, or polycarbonate with a polymer interlayer sheet disposed thereon, and most commonly, with a polymer film further disposed over the polymer interlayer. The combination of polymer interlayer sheet and polymer film is commonly referred to in the art as a bilayer. A typical multiple layer panel with a bilayer construct is: (glass)//(polymer interlayer sheet)//(polymer film), where the polymer interlayer sheet can comprise multiple interlayers, as noted above. The polymer film supplies a smooth, thin, rigid substrate that affords better optical character than that usually obtained with a polymer interlayer sheet alone and functions as a performance enhancing layer. Polymer films differ from polymer interlayer sheets, as used herein, in that polymer films do not themselves provide the necessary penetration resistance and glass retention properties, but rather provide performance improvements, such as infrared absorption characteristics. Poly(ethylene terephthalate) (“PET”) is the most commonly used polymer film. Generally, as used herein, a polymer film is thinner than a polymer sheet, such as from about 0.001 to 0.2 mm thick.

The interlayers of the present disclosure will most commonly be utilized in multiple layer panels comprising two substrates, such as a pair of glass sheets (or other rigid materials, such as polycarbonate or acrylic, known in the art), with the interlayers disposed between the two substrates. An example of such a construct would be: (glass)//(polymer interlayer sheet)//(glass), where the polymer interlayer sheet can comprise multilayered interlayers, as noted above. These examples of multiple layer panels are in no way meant to be limiting, as one of ordinary skill in the art would readily recognize that numerous constructs other than those described above could be made with the interlayers of the present disclosure.

The typical glass lamination process comprises the following steps: (1) assembly of the two substrates (e.g., glass) and interlayer; (2) heating the assembly via an IR radiant or convective means for a short period; (3) passing the assembly into a pressure nip roll for the first deairing; (4) heating the assembly a second time to about 60° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperatures between 135° C. and 150° C. and pressures between 180 psig and 200 psig for about 30 to 90 minutes. The actual steps, as well as the times and temperatures, may vary as necessary, as known by one skilled in the art. Other means for use in de-airing of the interlayer-glass interfaces (steps 2-5) known in the art and that are commercially practiced include vacuum bag and vacuum ring processes in which a vacuum is utilized to remove the air.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are intended to be reported precisely in view of methods of measurement. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the denomination of process steps, ingredients, or other aspects of the information disclosed or claimed in the application with letters, numbers, or the like is a convenient means for identifying discrete activities or ingredients and the recited lettering can be arranged in any sequence, unless otherwise indicated.

As used herein, the singular forms “a”, “an”, and “the” include plural referents unless the context clearly dictates otherwise. For example, reference to a Cn alcohol equivalent is intended to include multiple types of Cn alcohol equivalents. Thus, even use of language such as “at least one” or “at least some” in one location is not intended to imply that other uses of “a”, “an”, and “the” excludes plural referents unless the context clearly dictates otherwise. Similarly, use of the language such as “at least some” in one location is not intended to imply that the absence of such language in other places implies that “all” is intended, unless the context clearly dictates otherwise.

As used herein the term “and/or”, when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

### EXAMPLES

### Comparative Example 1 (Prophetic)

10 kg of varnish containing 5 weight percent soft PVB is compounded with 10 kg of soft acoustic PVB resin powder in a twin-screw extruder, then pelletized. The resulting pellets have 90.5 phr plasticizer.

### Example 1 (Prophetic)

5 kg of varnish containing 5 weight percent soft PVB is compounded with 10 kg of soft acoustic PVB resin powder in a twin-screw extruder, then pelletized. The resulting pellets have 46.3 phr plasticizer. These pellets are dusted with 0.0-1.0 phr soft acoustic PVB resin powder to reduce stickiness. These pellets are then fed into a continuous mixer, together with additional plasticizers and adhesion control additives to reach a target plasticizer composition of 70-80 phr, before being discharged into an extruder for PVB sheet extrusion.

### Example 2 (Prophetic)

5 kg of varnish containing 5 weight percent soft PVB is compounded with 10 kg of soft acoustic PVB resin powder in a twin-screw extruder, then pelletized. The resulting pellets have 46.3 phr plasticizer. These pellets are dusted with 0.0-1.0 phr soft acoustic PVB resin powder to reduce stickiness. These pellets are then fed into a twin-screw extruder for PVB sheet extrusion. Additional plasticizers and adhesion control additives are then injected to reach a target plasticizer composition of 70-80 phr.

### Example 3 (Prophetic)

4 kg of varnish containing 5 weight percent soft PVB is compounded with 12 kg of soft acoustic PVB resin powder in a twin-screw extruder, and then pelletized. The resulting pellets have 31.1 phr plasticizer. These pellets are then dusted with 0.0-1.0 phr soft acoustic PVB resin powder to reduce stickiness. These pellets are fed into a continuous mixer, together with additional plasticizers and adhesion control additives to reach a target plasticizer composition of 70-80 phr, before being discharged into an extruder for PVB sheet extrusion.

### Example 4 (Prophetic)

4 kg of varnish containing 5 weight percent soft PVB is compounded with 12 kg of soft acoustic PVB resin powder in a twin-screw extruder, and then pelletized. The resulting pellets have 31.1 phr plasticizer. These pellets are then dusted with 0.0-1.0 phr soft acoustic PVB resin powder to reduce stickiness. These pellets are fed into a twin-screw extruder for PVB sheet extrusion. Additional plasticizers and adhesion control additives are then injected to reach a target plasticizer composition of 70-80 phr.

### Comparative Example 2 (Prophetic)

10 kg of varnish containing 10 weight percent soft PVB is compounded with 10 kg of soft acoustic PVB resin powder in a twin-screw extruder, and then pelletized. The resulting pellets have 81.8 phr plasticizer.

### Example 5 (Prophetic)

5 kg of varnish containing 10 weight percent soft PVB is compounded with 10 kg of soft acoustic PVB resin powder in a twin-screw extruder, and then pelletized. The resulting pellets have 42.9 phr plasticizer. These pellets are then dusted with 0.0-1.0 phr soft acoustic PVB resin powder to reduce stickiness. These pellets are fed into a continuous mixer, together with additional plasticizers and adhesion control additives to reach a target plasticizer composition of 70-80 phr, before being discharged into an extruder for PVB sheet extrusion.

### Example 6 (Prophetic)

5 kg of varnish containing 10 weight percent soft PVB is compounded with 10 kg of soft acoustic PVB resin powder in a twin-screw extruder, and then pelletized. The resulting pellets have 42.9 phr plasticizer. These pellets are then dusted with 0.0-1.0 phr soft acoustic PVB resin powder to reduce stickiness. These pellets are fed into a twin-screw extruder for PVB sheet extrusion. Additional plasticizers and adhesion control additives are then injected to reach a target plasticizer composition of 70-80 phr.

### Example 7 (Prophetic)

4 kg of varnish containing 10 weight percent soft PVB is compounded with 12 kg of soft acoustic PVB resin powder in a twin-screw extruder, and then pelletized. The resulting pellets have 29.0 phr plasticizer. These pellets are then dusted with 0.0-1.0 phr soft acoustic PVB resin powder to reduce stickiness. These pellets are then fed into a continuous mixer, together with additional plasticizers and adhesion control additives to reach a target plasticizer composition of 70-80 phr, before being discharged into an extruder for PVB sheet extrusion.

### Example 8 (Prophetic)

4 kg of varnish containing 10 weight percent soft PVB is compounded with 12 kg of soft acoustic PVB resin powder in a twin-screw extruder, and then pelletized. The resulting pellets have 29.0 phr plasticizer. These pellets are then dusted with 0.0-1.0 phr soft acoustic PVB resin powder to reduce stickiness. These pellets were fed into a twin-screw extruder for PVB sheet extrusion. Additional plasticizers and adhesion control additives were injected to reach a target plasticizer composition of 70-80 phr.

### Example 9

10 kg of varnish containing 15 weight percent soft PVB was compounded with 10 kg of soft acoustic PVB resin powder in a twin-screw extruder, then pelletized. The resulting pellets had 73.9 phr plasticizer. These pellets were dusted with 0.0-1.0 phr soft acoustic PVB resin powder to reduce stickiness. These pellets were fed into a continuous mixer, together with additional plasticizers and adhesion control additives to reach a target plasticizer composition of 74-80 phr, before being discharged into an extruder for PVB sheet extrusion. The resulting PVB was thus found suitable for use as the core of an acoustic interlayer.

### Example 10

10 kg of varnish containing 15 weight percent soft PVB was compounded with 10 kg of soft acoustic PVB resin powder in a twin-screw extruder, then pelletized. The resulting pellets had 73.9 phr plasticizer. These pellets were dusted with 0.0-1.0 phr soft acoustic PVB resin powder to reduce stickiness. These pellets were fed into a twin-screw extruder for PVB sheet extrusion. Additional plasticizers and adhesion control additives were injected to reach a target plasticizer composition of 74-80 phr. The resulting PVB was thus found suitable for use as the core of an acoustic interlayer.

### Example 11

5 kg of varnish containing 15 weight percent soft PVB was compounded with 10 kg of soft acoustic PVB resin powder in a twin-screw extruder, then pelletized. The resulting pellets had 39.5 phr plasticizer. These pellets were dusted with 0.0-1.0 phr soft acoustic PVB resin powder to reduce stickiness. These pellets were fed into a continuous mixer, together with additional plasticizers and adhesion control additives to reach a target plasticizer composition of 70-80 phr, before being discharged into an extruder for PVB sheet extrusion. The resulting PVB was thus found suitable for use as the core of an acoustic interlayer.

### Example 12

5 kg of varnish containing 15 weight percent soft PVB was compounded with 10 kg of soft acoustic PVB resin powder in a twin-screw extruder, then pelletized. The resulting pellets had 39.5 phr plasticizer. These pellets were dusted with 0.0-1.0 phr soft acoustic PVB resin powder to reduce stickiness. These pellets were fed into a twin-screw extruder for PVB sheet extrusion. Additional plasticizers and adhesion control additives were injected to reach a target plasticizer composition of 70-80 phr. The resulting PVB was thus found suitable for use as the core of an acoustic interlayer.

### Example 13

4 kg of varnish containing 15 weight percent soft PVB was compounded with 12 kg of soft acoustic PVB resin powder in a twin-screw extruder, then pelletized. The resulting pellets had 27.0 phr plasticizer. These pellets were dusted with 0.0-1.0 phr soft acoustic PVB resin powder to reduce stickiness. These pellets were fed into a continuous mixer, together with additional plasticizers and adhesion control additives to reach a target plasticizer composition of 70-80 phr, before being discharged into an extruder for PVB sheet extrusion. The resulting PVB was thus found suitable for use as the core of an acoustic interlayer.

### Example 14

4 kg of varnish containing 15 weight percent soft PVB was compounded with 12 kg of soft acoustic PVB resin powder in a twin-screw extruder, then pelletized. The resulting pellets had 27.0 phr plasticizer. These pellets were dusted with 0.0-1.0 phr soft acoustic PVB resin powder to reduce stickiness. These pellets were fed into a twin-screw extruder for PVB sheet extrusion. Additional plasticizers and adhesion control additives were injected to reach a target plasticizer composition of 70-80 phr. The resulting PVB was thus found suitable for use as the core of an acoustic interlayer.

### Example 15 (Prophetic)

10 kg of varnish containing 20 weight percent soft PVB is compounded with 10 kg of soft acoustic PVB resin powder in a twin-screw extruder, and then pelletized. The resulting pellets have 66.7 phr plasticizer. These pellets were dusted with 0.0-1.0 phr soft acoustic PVB resin powder to reduce stickiness. These pellets are then fed into a continuous mixer, together with additional plasticizers and adhesion control additives to reach a target plasticizer composition of 70-80 phr, before being discharged into an extruder for PVB sheet extrusion.

### Example 16 (Prophetic)

10 kg of varnish containing 20 weight percent soft PVB is compounded with 10 kg of soft acoustic PVB resin powder in a twin-screw extruder, and then pelletized. The resulting pellets have 66.7 phr plasticizer. These pellets are dusted with 0.0-1.0 phr soft acoustic PVB resin powder to reduce stickiness. These pellets are then fed into a twin-screw extruder for PVB sheet extrusion. Additional plasticizers and adhesion control additives are injected to reach a target plasticizer composition of 70-80 phr.

### Example 17 (Prophetic)

5 kg of varnish containing 20 weight percent soft PVB is compounded with 10 kg of soft acoustic PVB resin powder in a twin-screw extruder, and then pelletized. The resulting pellets have 36.4 phr plasticizer. These pellets are dusted with 0.0-1.0 phr soft acoustic PVB resin powder to reduce stickiness. These pellets are then fed into a continuous mixer, together with additional plasticizers and adhesion control additives to reach a target plasticizer composition of 70-80 phr, before being discharged into an extruder for PVB sheet extrusion.

### Example 18 (Prophetic)

5 kg of varnish containing 20 weight percent soft PVB is compounded with 10 kg of soft acoustic PVB resin powder in a twin-screw extruder, and then pelletized. The resulting pellets have 36.4 phr plasticizer. These pellets are then dusted with 0.0-1.0 phr soft acoustic PVB resin powder to reduce stickiness. These pellets are fed into a twin-screw extruder for PVB sheet extrusion. Additional plasticizers and adhesion control additives are injected to reach a target plasticizer composition of 70-80 phr.

### Example 19 (Prophetic)

4 kg of varnish containing 20 weight percent soft PVB is compounded with 12 kg of soft acoustic PVB resin powder in a twin-screw extruder, and then pelletized. The resulting pellets have 25.0 phr plasticizer. These pellets are then dusted with 0.0-1.0 phr soft acoustic PVB resin powder to reduce stickiness. These pellets are fed into a continuous mixer, together with additional plasticizers and adhesion control additives to reach a target plasticizer composition of 70-80 phr, before being discharged into an extruder for PVB sheet extrusion.

### Example 20 (Prophetic)

4 kg of varnish containing 20 weight percent soft PVB is compounded with 12 kg of soft acoustic PVB resin powder in a twin-screw extruder, and then pelletized. The resulting pellets have 25.0 phr plasticizer. These pellets are dusted with 0.0-1.0 phr soft acoustic PVB resin powder to reduce stickiness. These pellets are then fed into a twin-screw extruder for PVB sheet extrusion. Additional plasticizers and adhesion control additives are injected to reach a target plasticizer composition of 70-80 phr.

### Example 21 (Prophetic)

10 kg of varnish containing 25 weight percent soft PVB is compounded with 10 kg of soft acoustic PVB resin powder in a twin-screw extruder, and then pelletized. The resulting pellets have 60.0 phr plasticizer. These pellets are dusted with 0.0-1.0 phr soft acoustic PVB resin powder to reduce stickiness. These pellets are then fed into a continuous mixer, together with additional plasticizers and adhesion control additives to reach a target plasticizer composition of 70-80 phr, before being discharged into an extruder for PVB sheet extrusion.

### Example 22 (Prophetic)

10 kg of varnish containing 25 weight percent soft PVB is compounded with 10 kg of soft acoustic PVB resin powder in a twin-screw extruder, and then pelletized. The resulting pellets have 60.0 phr plasticizer. These pellets are dusted with 0.0-1.0 phr soft acoustic PVB resin powder to reduce stickiness. These pellets are then fed into a twin-screw extruder for PVB sheet extrusion. Additional plasticizers and adhesion control additives are injected to reach a target plasticizer composition of 70-80 phr.

### Example 23 (Prophetic)

5 kg of varnish containing 25 weight percent soft acoustic PVB is compounded with 10 kg of soft acoustic PVB resin powder in a twin-screw extruder, and then pelletized. The resulting pellets have 33.3 phr plasticizer. These pellets are then dusted with 0.0-1.0 phr soft acoustic PVB resin powder to reduce stickiness. These pellets are fed into a continuous mixer, together with additional plasticizers and adhesion control additives to reach a target plasticizer composition of 70-80 phr, before being discharged into an extruder for PVB sheet extrusion.

### Example 24 (Prophetic)

5 kg of varnish containing 25 weight percent soft PVB is compounded with 10 kg of soft acoustic PVB resin powder in a twin-screw extruder, and then pelletized. The resulting pellets have 33.3 phr plasticizer. These pellets are dusted with 0.0-1.0 phr soft acoustic PVB resin powder to reduce stickiness. These pellets are fed into a twin-screw extruder for PVB sheet extrusion. Additional plasticizers and adhesion control additives are injected to reach a target plasticizer composition of 70-80 phr.

### Example 25 (Prophetic)

4 kg of varnish containing 25 weight percent soft PVB is compounded with 12 kg of soft acoustic PVB resin powder in a twin-screw extruder, and then pelletized. The resulting pellets have 23.1 phr plasticizer. These pellets are dusted with 0.0-1.0 phr soft acoustic PVB resin powder to reduce stickiness. These pellets are fed into a continuous mixer, together with additional plasticizers and adhesion control additives to reach a target plasticizer composition of 70-80 phr, before being discharged into an extruder for PVB sheet extrusion.

### Example 26 (Prophetic)

4 kg of varnish containing 25 weight percent soft PVB is compounded with 12 kg of soft acoustic PVB resin powder in a twin-screw extruder, and then pelletized. The resulting pellets have 23.1 phr plasticizer. These pellets are dusted with 0.0-1.0 phr soft acoustic PVB resin powder to reduce stickiness. These pellets are then fed into a twin-screw extruder for PVB sheet extrusion. Additional plasticizers and adhesion control additives are injected to reach a target plasticizer composition of 70-80 phr.

TABLE 1
Summary of the Examples.

| | | | Plasticizer (PHR) after compounded | | |
|---|---|---|---|---|---|
| | | | with additional soft PVB resin | | |
| | Varnish | | (Part per hundred varnish) | | |
| | Soft PVB | Plasti- | 100 parts | 200 parts | 300 parts |
| | content | cizer | soft PVB | soft PVB | soft PVB |
| Example | (weight %) | (PHR) | resin | resin | resin |
| Comp. 1 | 5 | 1,900 | 90.5 | | |
| 1, 2 | | | | 46.3 | |
| 3, 4 | | | | | 31.1 |
| Comp. 2 | 10 | 900 | 81.8 | | |
| 5, 6 | | | | 42.9 | |
| 7, 8 | | | | | 29.0 |
| 9, 10 | 15 | 567 | 73.9 | | |
| 11, 12 | | | | 39.5 | |
| 13, 14 | | | | | 27.0 |
| 15, 16 | 20 | 400 | 66.7 | | |
| 17, 18 | | | | 36.4 | |
| 19, 20 | | | | | 25.0 |
| 21, 22 | 25 | 300 | 60.0 | | |
| 23, 24 | | | | 33.3 | |
| 25, 26 | | | | | 23.1 |

1. A process for recovering soft poly(vinyl butyral) from a plasticized poly(vinyl butyral) multilayer sheet comprising stiff poly(vinyl butyral) and soft poly(vinyl butyral), the process comprising:
a. grinding the plasticized poly(vinyl butyral) multilayer sheet to obtain a poly(vinyl butyral) granulate;
b. adding additional plasticizer to the poly(vinyl butyral) granulate to remove at least a portion of the soft poly(vinyl butyral) from the poly(vinyl butyral) granulate to obtain (i) a granulate enriched in the stiff poly(vinyl butyral) and (ii) a varnish of the soft poly(vinyl butyral) and the additional plasticizer;
c. physically separating the granulate enriched in the stiff poly(vinyl butyral) from the varnish of the soft poly(vinyl butyral) and the additional plasticizer, wherein the varnish has a first concentration of plasticizer; and
d. adding under-plasticized poly(vinyl butyral) to the varnish, to provide a soft poly(vinyl butyral) composition having a lower concentration of plasticizer than the first concentration.

2. The process of claim 1, wherein the under-plasticized poly(vinyl butyral) comprises up to about 45 phr of plasticizer.

3. The process of claim 1, wherein the under-plasticized poly(vinyl butyral comprises about 0 to about 1 phr.

4. The process of claim 1, wherein the soft poly(vinyl butyral) composition having a lower concentration of plasticizer has a concentration of plasticizer in the range of about 20 to about 80 phr.

5. The process of claim 4, further comprising the step of pelletizing the soft poly(vinyl butyral) composition.

6. The process of claim 4, further comprising the step of forming the soft poly(vinyl butyral) composition into pellets and dusting the pellets with a soft poly(vinyl butyral) resin in powder form having less than or equal to about 1 phr of plasticizer.

7. The process of claim 1, wherein the plasticizer is chosen from one or more of esters of a polybasic acid or polyhydric alcohol.

8. The process of claim 1, wherein the additional plasticizer is chosen from one or more of triethylene glycol bis(2-ethylhexanoate), tetraethylene glycol bis(2-ethylhexanoate), triethylene glycol bis(2-ethylbutyrate), triethylene glycol diheptanoate, tetraethylene glycol diheptanoate, dihexyl adipate, bis(2ethylhexyl) adipate, bis(2-ethoxyethyl) adipate, dioctyl adipate, hexyl cyclohexyladipate, diisononyl adipate, heptylnonyl adipate, dibutyl sebacate, polymeric adipates, a soybean oil, or an epoxidized soybean oil.

9. The process of claim 1, wherein the additional plasticizer is added to the poly(vinyl butyral) granulate at a temperature of about 25° C. to about 90° C.

10. The process of claim 1, wherein the soft poly(vinyl butyral) has a residual hydroxyl content of from about 8% to about 12%.

11. The process of claim 1, wherein the stiff poly(vinyl butyral) has a residual hydroxyl content of from about 15% to about 25%.

12. The process of claim 1, wherein the soft poly(vinyl butyral) has a residual acetate content less than about 15%.

13. The process of claim 1, wherein the soft poly(vinyl butyral) contained in the plasticized poly(vinyl butyral) multilayer sheet initially comprises triethylene glycol bis(2-ethylhexanoate) present as a plasticizer.

14. The process of claim 1, wherein the soft poly(vinyl butyral) contained in the plasticized poly(vinyl butyral) multilayer sheet further comprises dihexyladipate present as a plasticizer.

15. The process of claim 1, wherein the triethylene glycol bis(2-ethylhexanoate) is initially present in the soft poly(vinyl butyral) in an amount from about 60 phr to about 100 phr.

16. The process of claim 1, wherein the additional plasticizer added to the poly(vinyl butyral) granulate in step b) comprises triethylene glycol bis(2-ethylhexanoate).

17. The process of claim 1, wherein the difference between the residual hydroxyl content of the soft poly(vinyl butyral) and the residual hydroxyl content of the stiff poly(vinyl butyral) is at least 4.0 weight percent.

18. The process of claim 1, further comprising forming the soft poly(vinyl butyral) composition into a sheet.

19. A poly(vinyl butyral) sheet comprising the isolated soft poly(vinyl butyral) composition of claim 1.

20. A laminated glass comprising the poly(vinyl butyral) sheet of claim 19.
